(19) United States
(12) Patent Application Publication
(10) Pub. No.: US 2013/0287889 A1
(43) Pub. Date: Oct. 31, 2013

(54) NOZZLE-TIP APPARATUS INCLUDING A NOZZLE-TIP BODY HAVING PRESSURE-RELIEF FEATURE

(71) Applicant: Gregory Ray Hammond, Georgetown (CA)

(72) Inventor: Gregory Ray Hammond, Georgetown (CA)

(21) Appl. No.: 13/995,349

(22) PCT Filed: Jan. 5, 2012
(86) PCT No.: PCT/CA2012/050002

§ 371 Date: Jun. 18, 2013

Related U.S. Application Data
(60) Provisional application No. 61/434,458, filed on Jan. 20, 2011.

(51) Int. Cl. B29C 45/20

(52) U.S. Cl. CPC B29C 45/20
USPC 425/568

(57) ABSTRACT

A nozzle-tip apparatus (100), comprising: a nozzle-tip body (102) configured to connect with a molding-nozzle assembly (200). The nozzle-tip body (102) has a front end (104) defining an exit orifice (106). The exit orifice (106) is configured to slidably receive a valve stem (202) of the molding-nozzle assembly (200). The nozzle-tip body (102) has a pressure-relief feature (108).

### TECHNICAL FIELD

An aspect generally relates to (but is not limited to) a nozzle-tip apparatus including (and not limited to) a nozzle-tip body having a pressure-relief feature.

### BACKGROUND

U.S. Pat. No. 5,695,793 appears to disclose an injection molding valve member with head and neck portions, in which the injection molding valve member has a smaller neck portion leading to a short head portion. This facilitates the backflow of melt around the head portion as the valve member is driven forwardly to the closed position. In one embodiment, the neck portion is formed by a number of flutes spaced around the valve member having lands between them.

### SUMMARY

The inventor has researched a problem associated with known molding systems that inadvertently manufacture bad-quality molded articles or parts. After much study, the inventor believes he has arrived at an understanding of the problem and its solution, which are stated below, and the inventor believes this understanding is not known to the public.

A valve pin, valve stem or valve member of a known valve gated injection molding apparatus has a cylindrical or tapered front end and reciprocates between a retracted open position and a forward closed position in which the front end is seated in a gate. As a valve pin is driven forward to the closed position, some of the melt displaced by the valve pin may flow backwards around the valve pin to enable the valve pin to close. While valve pins having a cylindrical or tapered front end may be satisfactory for many applications, they may have the disadvantage that backflow is very restricted between the front end of the valve pin and the surrounding gate. This arrangement may result in a build up of back pressure in the melt as the valve pin is driven forwardly. It may be very difficult to find the right timing of closing the valve pin, particularly when molding crystalline materials, which may solidify much faster than amorphous materials. If the timing (movement) is not correct, the valve pin can may act like an injector and push melt or resin material into a semi-solidified part (being molded in a mold cavity), which may result in a product (molded part) which is stressed and therefore may be unacceptable and therefore rejected, thus leading to wastage and increased costs.

By improving the melt backflow as the valve pin advances to the closed position makes the exact timing of closing less critical and somewhat overcomes this problem. Also, in some cases the build up of back pressure in the melt prevents the valve pin from advancing and becoming completely seated in the gate and thus does not provide the molded product with a cosmetically clean gate mark. While additional force may be applied to the valve pin to try to overcome the back pressure problem, this may result in increasing wear and malfunction of the actuating mechanism of the valve pin.

According to an aspect, there is provided (to resolve the problem, at least in part) a nozzle-tip apparatus (100), comprising: a nozzle-tip body (102) configured to connect with a molding-nozzle assembly (200). The nozzle-tip body (102) has a front end (104) defining an exit orifice (106). The exit orifice (106) is configured to slidably receive a valve stem (202) of the molding-nozzle assembly (200). The nozzle-tip body (102) has a pressure-relief feature (108).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

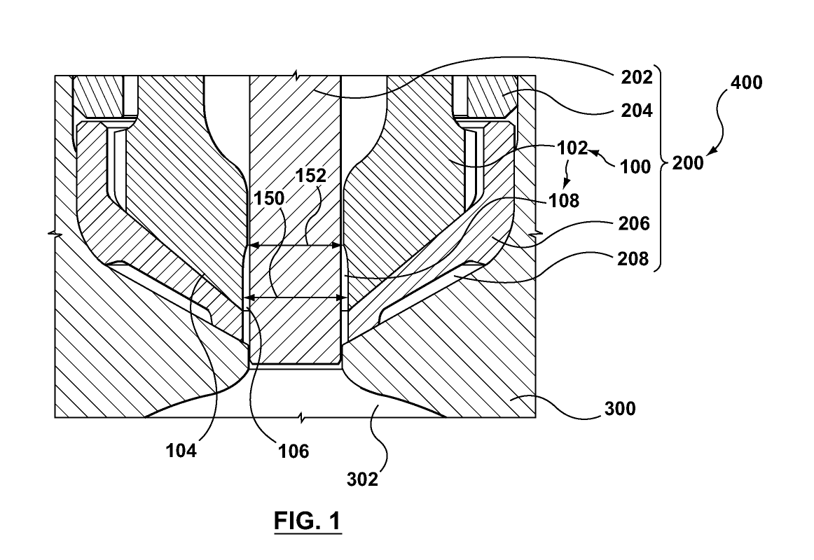

FIGS. 1, 2A, 2B, 3A, 3B depict schematic representations of, amongst other things, a nozzle-tip apparatus (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIG. 1 depicts the nozzle-tip apparatus (100), as well as, at least in part, a molding system (400) and a molding-nozzle assembly (200). The nozzle-tip apparatus (100), the molding system (400) and the molding-nozzle assembly (200) may all be supplied by one vendor or by different vendors. The molding-nozzle assembly (200) may have the nozzle-tip apparatus (100). The molding system (400) may have the molding-nozzle assembly (200). The nozzle-tip apparatus (100), the molding system (400) and the molding-nozzle assembly (200) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim, which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

Referring now to FIG. 1, the nozzle-tip apparatus (100) may include (and is not limited to): a nozzle-tip body (102) that may be configured to connect with a molding-nozzle assembly (200). The nozzle-tip body (102) may have a front end (104) that may define an exit orifice (106). The exit orifice (106) may be configured to slidably receive a valve stem (202) of the molding-nozzle assembly (200). The nozzle-tip body (102) has a pressure-relief feature (108). The above arrangement may prevent a buildup of back pressure in the melt as the valve member is driven forwardly, and this may improve the melt backflow as the valve stem (202) advances to the closed position to: (i) may make the exact timing of closing less critical and somewhat overcomes the problem, (ii) more likely to mold (produce) a cosmetically clean gate mark on the molded article, (iii) may reduce wear and malfunction of the actuating mechanism associated with the valve stem (202).

The molding-nozzle assembly (200) may include (and is not limited to): a nozzle housing (204), and a nozzle tip insulator (206) having a tip insulator relief (208), amongst other things. The molding-nozzle assembly (200) may be configured to deliver a melt to a gate insert (300) that defines a preform dome (302), which may be part of a mold cavity. More specifically, the pressure-relief feature (108) may be configured to permit, in use, a backflow of a resin and a back pressure reduction in front of the valve stem (202).

Referring now to FIG. 1, there is depicted an option for the pressure-relief feature (108). According to an option as depicted in FIG. 1, the pressure-relief feature (108) may include (and is not limited to): the exit orifice (106) that may have (and is not limited to): (i) a larger diameter (150) that may be located at the front end (104) of the nozzle-tip body (102), and (ii) a smaller diameter (152) that may be spaced apart rearwardly from the front end (104) of the nozzle-tip body (102). The larger diameter (150) and the smaller diameter (152) may be configured, in combination, to permit, in use, a backflow of a resin and a back pressure reduction in front of the valve stem (202). The larger diameter (150) is larger relative to the smaller diameter (152).

Note to GREG: is there anything else you wish to state about the tolerances of the larger diameter (150) and the smaller diameter (152)?

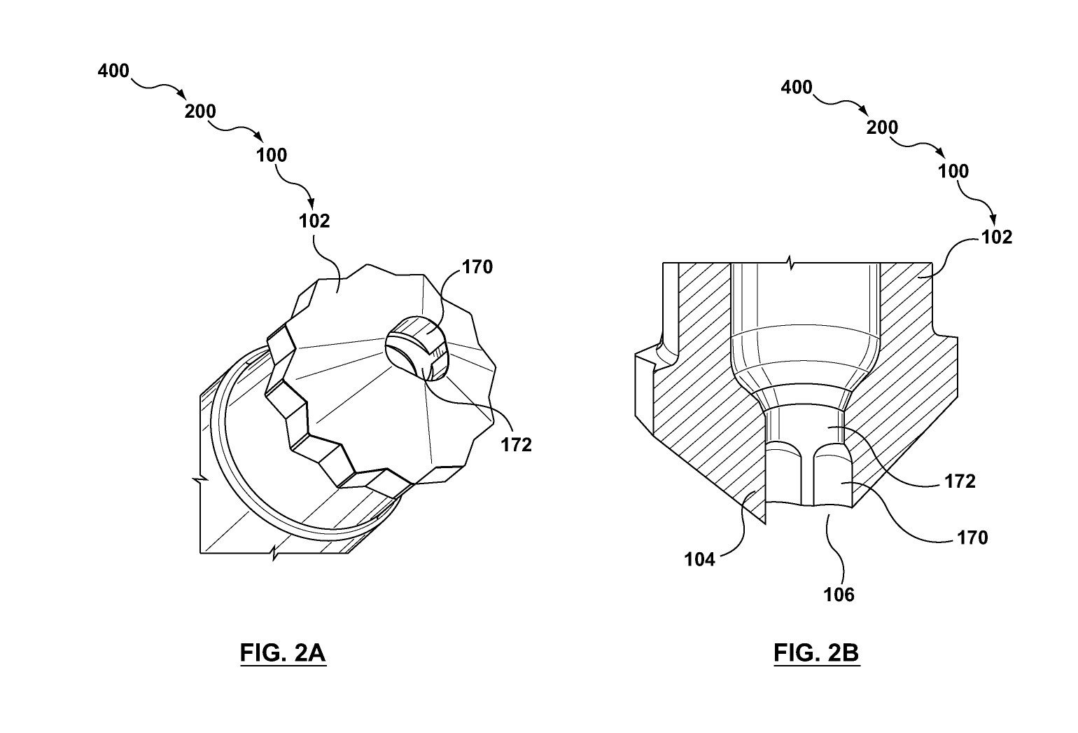

Referring now to FIGS. 2A and 2B, there is depicted another option for the pressure-relief feature (108). According to an option as depicted in FIGS. 2A and 2B, the pressure-relief feature (108) may include (and is not limited to): the nozzle-tip body (102) that may define a flute structure (170) that may extend from the front end (104) of nozzle-tip body (102) rearwardly along the exit orifice (106). The flute structure (170) may be a shallow relief. The flute structure (170) may define one or more flutes or shallow reliefs. The exit orifice (106) may provide a valve stem sliding face (172) for interfacing with the valve stem (202) of the molding-nozzle assembly (200). Optionally, the flute structure (170) may extend from the front end (104) of nozzle-tip body (102) rearwardly at least partially along a land length of the exit orifice (106).

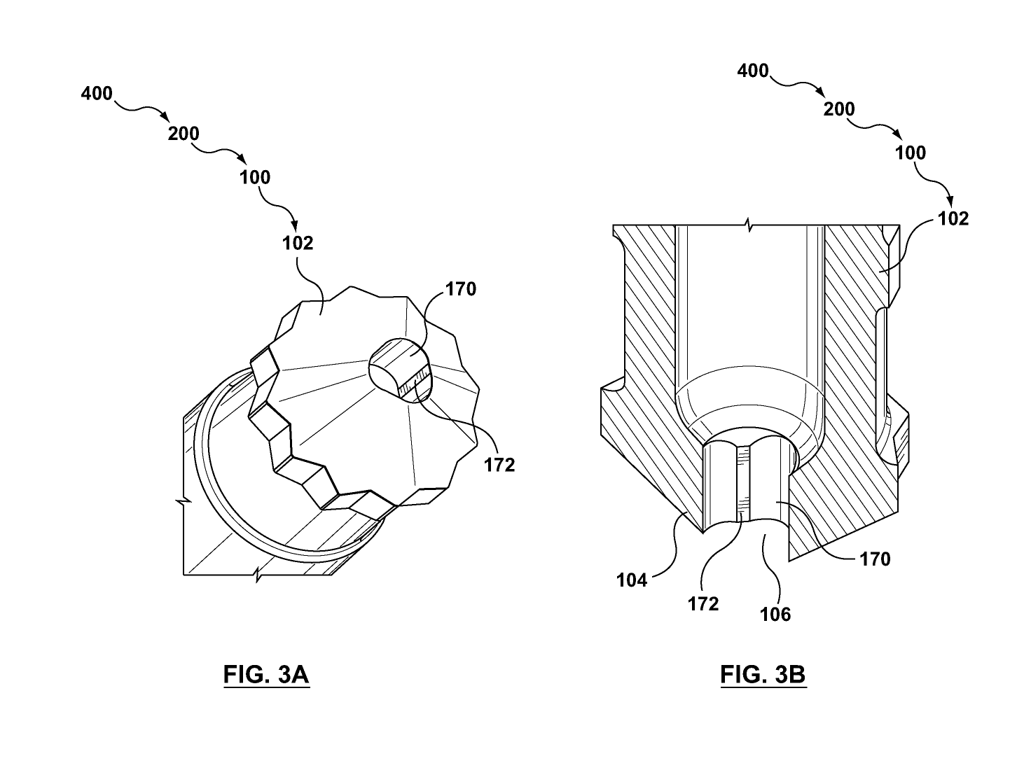

Referring now to FIGS. 3A and 3B, there is depicted another option for the pressure-relief feature (108). According to an option as depicted in FIGS. 2A and 2B, the pressure-relief feature (108) may include (and is not limited to): the nozzle-tip body (102) that may define the flute structure (170) that may extend from the front end (104) of nozzle-tip body (102) rearwardly along an entire land length of the exit orifice (106).

Note to GREG: is there anything else you wish to state in this application?

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

1. A nozzle-tip apparatus (100), comprising:
a nozzle-tip body (102) being configured to connect with a molding-nozzle assembly (200),
the nozzle-tip body (102) having a front end (104) defining an exit orifice (106), the exit orifice (106) being configured to slidably receive a valve stem (202) of the molding-nozzle assembly (200),
wherein the nozzle-tip body (102) defines a pressure-relief feature (108).

2. The nozzle-tip apparatus (100) of claim 1, wherein:
the pressure-relief feature (108) is configured to permit, in use, a backflow of a resin and a back pressure reduction in front of the valve stem (202).

3. The nozzle-tip apparatus (100) of claim 1, wherein:
the pressure-relief feature (108) includes:
the exit orifice (106) having a larger diameter (150) being located at the front end (104) of the nozzle-tip body (102), and also having a smaller diameter (152) being spaced apart rearwardly from the front end (104) of the nozzle-tip body (102), and
the larger diameter (150) and the smaller diameter (152) being configured, in combination, to permit, in use, a backflow of a resin and a back pressure reduction in front of the valve stem (202).

4. The nozzle-tip apparatus (100) of claim 1, wherein:
the pressure-relief feature (108) includes:
the nozzle-tip body (102) defining a flute structure (170) extending from the front end (104) of the nozzle-tip body (102) rearwardly along the exit orifice (106).

5. The nozzle-tip apparatus (100) of claim 1, wherein:
the pressure-relief feature (108) includes:
the nozzle-tip body (102) defining a flute structure (170) extending from the front end (104) of the nozzle-tip body (102) rearwardly at least partially along a land length of the exit orifice (106).

6. The nozzle-tip apparatus (100) of claim 1, wherein:
the pressure-relief feature (108) includes:
the nozzle-tip body (102) defining a flute structure (170) extending from the front end (104) of the nozzle-tip body (102) rearwardly along an entire land length of the exit orifice (106).

7. A molding-nozzle assembly (200) having a nozzle-tip apparatus (100), comprising:
a nozzle-tip body (102) being configured to connect with a molding-nozzle assembly (200),
the nozzle-tip body (102) having a front end (104) defining an exit orifice (106), the exit orifice (106) being configured to slidably receive a valve stem (202) of the molding-nozzle assembly (200),
wherein the nozzle-tip body (102) defines a pressure-relief feature (108).

8. A molding system (400) having a molding-nozzle assembly (200) having a nozzle-tip apparatus (100), comprising:
a nozzle tip body (102) being configured to connect with a molding-nozzle assembly (200),
the nozzle-tip body (102) having a front end (104) defining an exit orifice (106), the exit orifice (106) being configured to slidably receive a valve stem (202) of the molding-nozzle assembly (200),
wherein the nozzle-tip body (102) defines a pressure-relief feature (108).

9. The molding-nozzle assembly (200) of claim 7, wherein:
the pressure-relief feature (108) is configured to permit, in use, a backflow of a resin and a back pressure reduction in front of the valve stem (202).

10. The molding-nozzle assembly (200) of claim 7, wherein:
the pressure-relief feature (108) includes:
the exit orifice (106) having a larger diameter (150) being located at the front end (104) of the nozzle-tip body (102), and also having a smaller diameter (152) being spaced apart rearwardly from the front end (104) of the nozzle-tip body (102), and
the larger diameter (150) and the smaller diameter (152) being configured, in combination, to permit, in use, a backflow of a resin and a back pressure reduction in front to the valve stem (202).

11. The molding-nozzle assembly (200) of claim 7, wherein:
the pressure-relief feature (108) includes:
the nozzle-tip body (102) defining a flute (170) extending from the front end (104) of the nozzle-tip body (102) rearwardly along the exit orifice (106).

12. The molding-nozzle assembly (200) of claim 7, wherein:
the pressure relief feature (108) includes:
the nozzle-tip body (102) defining a flute structure (170) extending from the front end (104) of the nozzle-tip body (102) rearwardly at least partially along a land length of the exit orifice (106).

13. The molding-nozzle assembly (200) of claim 7, wherein:
the pressure-relief feature (108) includes:
the nozzle-tip body (102) defining a flute structure (170) extending from the front end (104) of the nozzle-tip body (102) rearwardly along an entire land length of the exit orifice (106).

14. The molding system (400) of claim 8, wherein:
the pressure-relief feature (108) is configured to permit, in use, a backflow of a resin and a back pressure reduction in front of the valve stem (202).

15. The molding system (400) of claim 8, wherein:
the pressure-relief feature (108) includes:
the exit orifice (106) having a larger diameter (150) being located at the front end (104) of the nozzle-tip body (102), and also having a smaller diameter (152) being spaced apart rearwardly from the front end (104) of the nozzle-tip body (102), and
the larger diameter (150) and the smaller diameter (152) being configured, in combination, to permit, in use, a backflow of a resin and a back pressure reduction in front of the valve stem (202).

16. The molding system (400) of claim 8, wherein:
the pressure-relief feature (108) includes:
the nozzle-tip body (102) defining a flute structure (170) extending from the front end (104) of the nozzle-tip body (102) rearwardly along the exit orifice (106).

17. The molding system (404) of claim 8, wherein:
the pressure-relief feature (108) includes:
the nozzle-tip body (102) defining a flute structure (170) extending from the front end (104) of the nozzle-tip body (102) rearwardly at least partially along a land length of the exit orifice (106).

18. The molding system (400) of claim 8, wherein:
the pressure-relief feature (108) includes:
the nozzle-tip body (102) defining a flute structure (170) extending from the front end (104) of the nozzle-tip body (102) rearwardly along an entire land length of the exit orifice (106).
